(19) United States
(12) Patent Application Publication
(10) Pub. No.: US 2012/0063123 A1
(43) Pub. Date: Mar. 15, 2012

(54) LASER PROJECTION BRA SYSTEM

(76) Inventors: Richard Redpath, Cary, NC (US); James Redpath, Cary, NC (US)

(21) Appl. No.: 12/878,970

(22) Filed: Sep. 9, 2010

(51) Int. Cl. F21V 21/08

(52) U.S. Cl. 362/103

(57) ABSTRACT

This invention relates to a woman's wardrobe for use in entertainment, and, in particular, on stage concerts for projection of laser light from a woman's body. The above system provides a unique small visual entertainment system that operates on batteries to enable the individual to walk about the stage.

### BACKGROUND OF INVENTION

This invention relates to a woman's bra for use in entertainment, and, in particular, on stage concerts for projection of laser light from a woman's body. The present invention provides a means to use a safe projection method of laser beams from a human body.

A woman's bra on stage has been used for entertainment purposes such as larger than normal support for breasts using cones. Furthermore, and more recently, pyrotechnics of projections of sparks and flames for entertainment have been used from a woman's body. In each reiteration an entertainer has tried to improve from one to the other. While prior art exists for different means for use of an implementation of a bra for on stage entertainment the current prior art of pyrotechnics is very dangerous.

In this respect, the Laser Projection Bra System invention substantially departs from the conventional design of the modern day prior art and in doing so provides a safe new entertainment system with a unique greater potential for distance projection.

### BRIEF SUMMARY OF INVENTION

The invention relates to a woman's bra for projection of laser light for use in entertainment, and, in particular, on stage concerts. In view of the prior art, the present invention provides a safe and unique entertainment system with greater impact to the audience viewing. The embodiment of the invention provides a battery operated containment to allow the user freedom on stage.

### BRIEF DESCRIPTION OF DRAWINGS

FIG. 1 is a diagram of the laser diffraction construction for the embodiment operation.

FIG. 2 is a circuit diagram for the embodiment.

FIG. 3A is a diagram of the embodiment enclosure for attachment to bra area.

FIG. 3B is a diagram of the enclosure panels of the laser operating system to be attached to the bra area.

FIG. 3C is a diagram of the placement areas for the embodiment on the human body.

FIG. 3D is a diagram of the embodiment mounted.

FIG. 4 is a diagram of the resulting projection from the embodiment on stage.

### DETAIL DESCRIPTION OF THE INVENTION

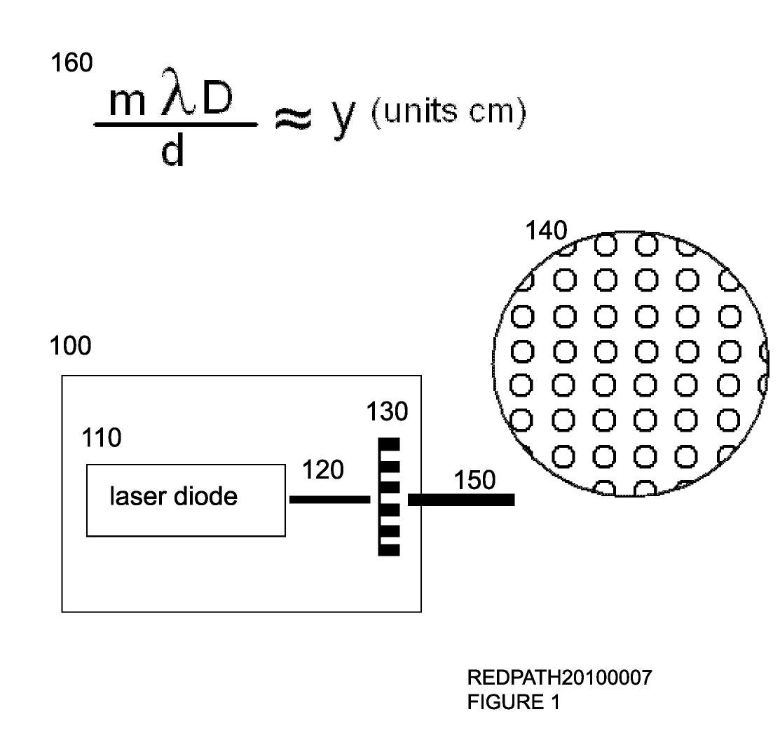

Referring to FIG. 1 at 100 is the operational embodiment which is constructed of a laser diode at 110 producing a beam at 120 to be incident with diffraction grating at 130. At 140 is a cross section of the output beam at 150 from the diffraction grating at 130.

An optimal diffraction grating at 130 for the embodiment to produce the effect of multiple laser beams can be calculated with the formula at 160. The displacement y is equal to the order m times the wavelength Lambda times the distance D divided by the slit separation d. The displacement from the center line for orders of m can be computed for optimal beam displacement. One skilled in the area of diffraction grating products can accurately compute the best diffraction grating but for completeness a 50 lines/mm diffraction grating is recommended. A 50 lines per millimeter diffraction grating has a slit separation of 20 micrometers 2.0 E-5 meters. Lamba is a green laser at 542 nm, D is a projection of 300 cm for an application such as a stage. Referring to FIG. 1 at 160 the formula result for a 50 lines/mm diffraction grating for first order m=1 computes a distance separation of approximately 8.13 cm. If the laser is red at 650 nm the displacement is 9.75 cm. For completeness the laser diode module at 110 should have a power output for safety of 5 mw to 10 mw at a wavelength of 532 nm with a divergence less than 1 mrad and beam diameter 1 mm.

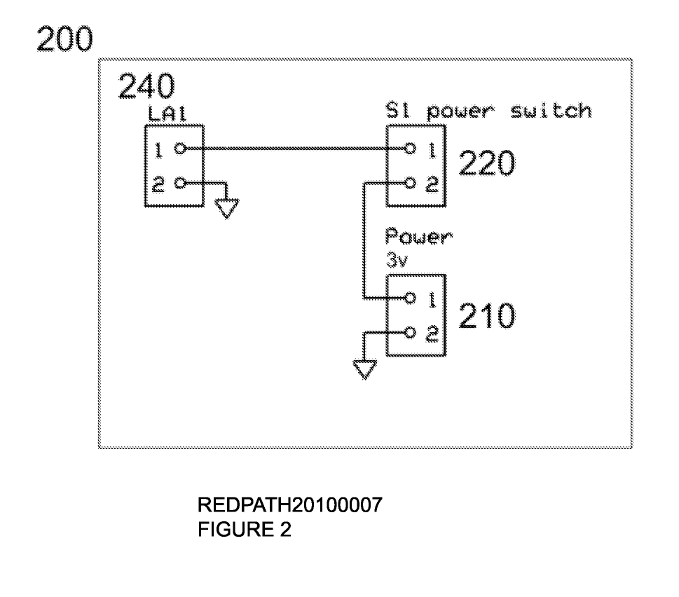

Referring to FIG. 2 at 200 is a circuit which uses a direct power supply such as a battery pack at 210 which is connected to a single throw single poll push button switch (SPST) at 220 which provides power to the laser diode module at 240. The laser diode at 240 typical weighs 16 g the battery pack at 210 is two lithium AAA batteries to achieve 3 v for 3 hours operation. The battery pack at 210 typically weighs 22 g. The total weight of the system at 200 is approximately 38 g and would not be uncomfortable to weigh. When including a plastic enclosure an additional 10 g would be added.

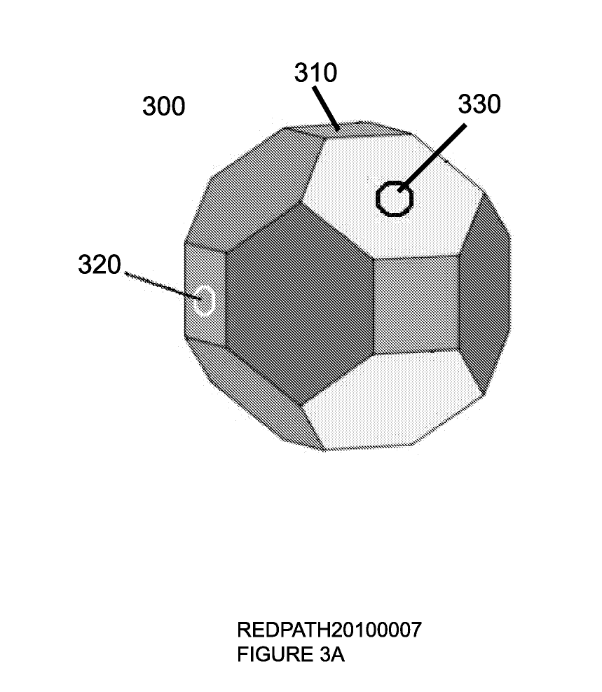

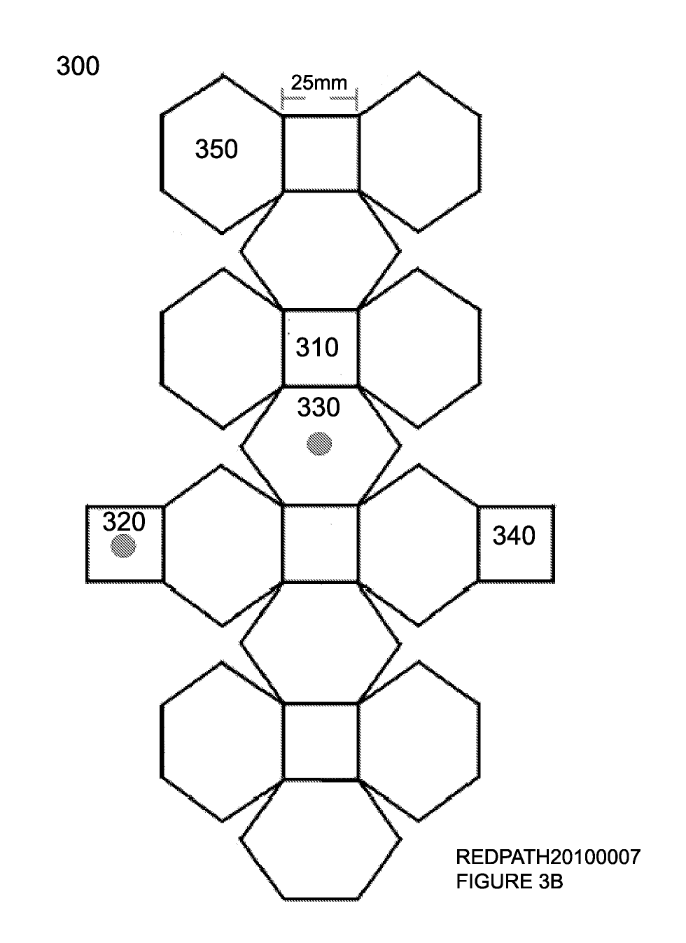

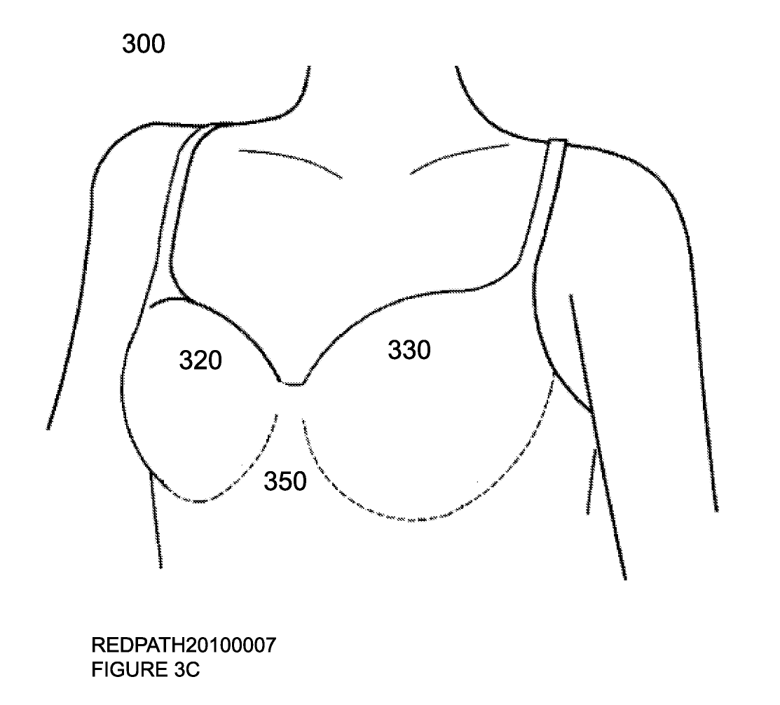

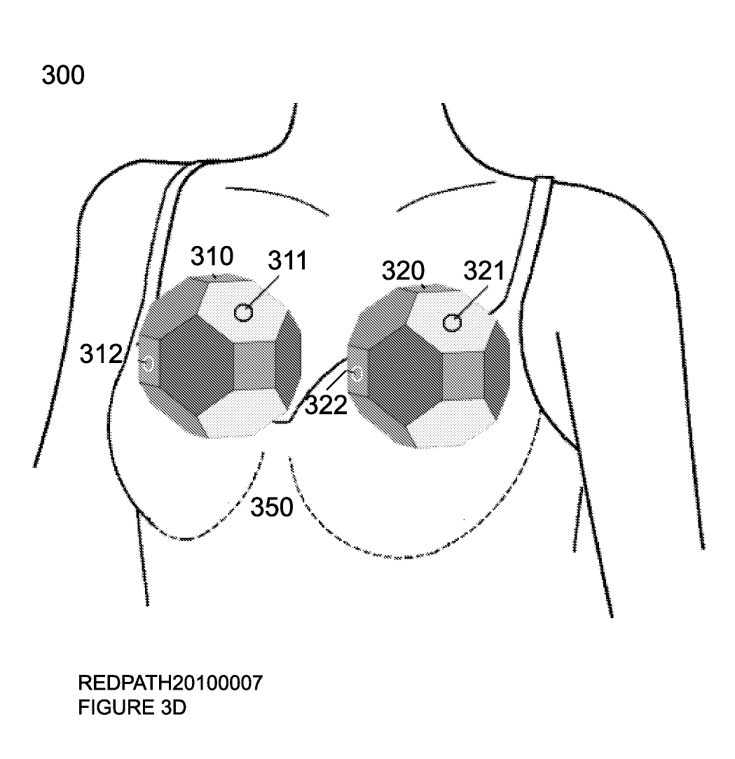

Referring to FIG. 3A at 300 is shown a three dimensional diagram of the embodiment container. The top is defined at 310 and is in context with FIG. 3B at 300 a foldable model. Referring to FIG. 3A at 330 is a single pole single throw (SPST) push button switch for the embodiment centered on the polygon. At 320 is the laser port diffraction grating output location. The polygons which construct the truncated rhombic dodecahedron at 300 enable the embodiment to stand stationary on a bra area using VECLOR®. The truncated rhombic dodecahedron is used as an implementation as it is quite easy to manufacture, is visually entertaining and it enables good leverage to stand on the breast area. Other containment systems can be envisioned as well as fiber optics to mount the laser on other parts of the body though not as efficient for optimal output usage of the laser.

Referring to FIG. 3B at 300 is a foldable diagram of a truncated rhombic dodecahedron for diagramming the location of parts for the embodiment container. The top is defined referring to FIG. 3b at 310 for reference in FIG. 3A at 310. In FIG. 3B at 330 is a single pole single throw (SPST) push button switch for the embodiment. At 320 is the laser port output diffraction. At 340 and 350 is the “hook” side of VECLOR® which is permanently glued to the panes.

Referring to FIG. 3C at 300 is an outline of a female body for wardrobe design. At 350 is an outline of the wardrobe breast area. At 320 and 330 is the “loop” side of VECLOR® which is permanently attached to the wardrobe breast upper area shelf. Referring to FIG. 3A is the enclosure embodiment at 300. Two enclosure embodiments at 300 are required to augment the two breasts in FIG. 2C at 300. Referring to FIG. 3B at 340 and 350 one unit of the embodiment at 300 is attached with VECLOR® to FIG. 3C at 320. Referring to FIG. 3B at 340 and 350 another unit of the embodiment at 300 is attached with VECLOR® to FIG. 3C at 330. Optionally the designer of the wardrobe may unite or fasten by stitches the VECLOR® areas when attached.

Referring to FIG. 3D at 300 is an outline of a female body for wardrobe design. At 350 is outlined the breast area. At 310 and 320 is the embodiment shelved on bra area referring to FIG. 3C at 320 and 330 using VECLOR®. At 311 and 321 is the push button for power and at 312 and 322 is the output of the laser pointing forward. One advantage of this mounting is that the user can remove the embodiment for others to inspect or give it away without the complexity of a wire harness.

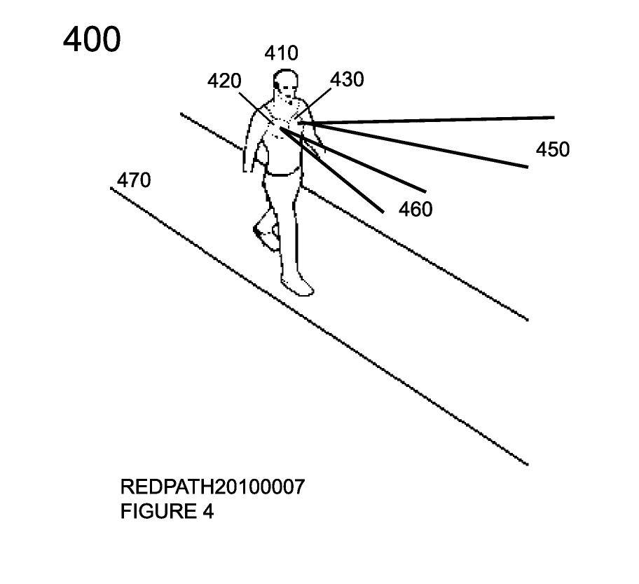

Referring to FIG. 4 at 400 is a entertainment stage diagram. At 470 is the stage area. At 410 is an entertainer wearing the embodiment at 420 and 430. At 450 and 460 is diagrammed the laser diffraction referring to FIG. 1 at 150 that is projected from the laser in FIG. 1 at 110 of the embodiment.

What is claimed is:

1. Laser Projection Bra System comprising the use of a laser mounted on the human body for stage entertainment.

2. Laser Projection Bra System of claim 1 comprising the use of a diffraction grating for added effect of multiple beams.

3. Laser Projection Bra System of claim 1 on other parts of the body for projection of laser light for stage entertainment.

4. Laser Projection Bra System of claim 1 for utilizing VECLOR® for attachment to enable a heterogeneous set of wardrobes to be used.

5. Laser Projection Bra System of claim 1 for utilizing a wire harness for attachment to the human body.
